(19) United States
(12) Patent Application Publication
(10) Pub. No.: US 2002/0116335 A1
(43) Pub. Date: Aug. 22, 2002

(54) Shared location financial transactions

(76) Inventor: Barry Star, Winchester, MA (US)

Correspondence Address: FOLEY HOAG LLP, PATENT GROUP, 155 SEAPORT BOULEVARD, BOSTON, MA, 02110, US

(21) Appl. No.: 10/042,874

(22) Filed: Jan. 9, 2002

Related U.S. Application Data
(60) Provisional application No. 60/260,537, filed on Jan. 9, 2001.

(51) Int. Cl. G06F 17/60

(52) U.S. Cl. 705/42; 705/44

(57) ABSTRACT

The present invention permits a financial institution to operate without geographic restriction, provide remote transaction and deposit handling, and supply an additional channel of customer support. Preferably, the transactions handled by the shared location do not require regulatory oversight and avoid the costs associated with branch offices. Furthermore, the invention can provide a better ability to prevent fraudulent transactions. The financial institution can be a member or subscriber of a service providing a shared location network. Furthermore, these institutions can operate without their employees at these sites.

The benefit of U.S. Provisional Patent Application No. 60/260,537, filed Jan. 9, 2001, entitled “Systems and Methods for Accepting and Handling Deposits for Multiple Financial Institutions”, which is hereby incorporated by reference, is claimed.

### BACKGROUND OF THE INVENTION

Branch locations are essential to financial institutions to receive deposits and to conduct other transactions with customers. Additionally, customers frequently open new accounts in a financial institution's branch location. In some sectors of the financial industry, such as banking, a physical presence or location is required to obtain access to customers. However, few businesses in the financial industry have the resources or inclination to develop an extensive network of locations because such of the outlay in capital and human resources required. Such a network of locations can also be limited by areas in which the financial institution is permitted by law or regulation to operate.

Additionally, fraudulent transactions threaten the security of institutional deposits and are believed to cause billions of dollars of in loss in the financial industry each year. Preventing fraud by implementing security measures can be costly because of the equipment and training required to correctly detect suspicious transactions.

### SUMMARY OF THE INVENTION

The various aspects of the present invention permit a financial institution to operate without geographic restriction, provide remote transaction and deposit handling, and supply an additional channel of customer support. Preferably, the transactions handled by the shared location do not require regulatory oversight and avoid the costs associated with branch offices. Furthermore, the invention can provide a better ability to prevent fraudulent transactions. The financial institution can be a member or subscriber of a service providing a shared location network. Furthermore, these institutions can operate without their employees at these sites.

The invention provides a method for receiving transaction data for a plurality of financial institutions at a shared location by receiving first data about a first transaction for a first financial institution at a shared location, receiving second data about a second transaction for a second financial institution at the shared location. The corresponding data can be provided to the respective financial institution through the shared location. Upon receipt of the transaction data, the respective financial institution can process the transaction. The received data can identify the transaction details for the financial institution such that further processing can occur without the original documents. The data could include an account identifier for the financial institution. In some instances, the account identifier can be an alphanumeric sequence. Particular data for the transaction also includes a customer identifier and a transaction amount. The customer identifier can be a personal identification code or a biometric measurement of a customer such as a signature, a fingerprint, a voiceprint, a face scan, and a retinal scan. In an additional aspect of the invention a transaction record can be printed and provided to a customer in a form such as a deposit receipt personalized for his financial institution. In one embodiment, an image of the customer, for instance, the face of the customer, can be provided on the transaction record. A printed transaction record in the form of a receipt can also be provided for a deposit to an account or other transactions, and can include images of various items including, but not limited to checks, deposit tickets or any other document.

In particular, a transaction record for a deposit to an account or other transactions can include an amount of a transaction, an account identifier, and an image depicting a customer's face. A printed deposit receipt provided to a customer need not include an image of the customer's face. A transaction record or printed deposit receipt can further comprise an image of a negotiable instrument or an image of a deposit slip submitted by the customer for the transaction.

Another aspect of the invention is a shared location, having an agent not employed by any financial institutions using the system of the present invention, and capable of receiving transaction data from many customers for any of a number of member financial institutions. The location can have an image recorder and a printer for generating printed transaction records and/or a videoconferencing apparatus to permit an informative transaction between the customer and the member financial institution. The shared location can be part of a network of affiliated storefronts.

### BRIEF DESCRIPTION OF THE DRAWINGS

FIG. 1 illustrates a transaction or document delivery method of the invention.

FIG. 2 depicts a deposit record in accordance with the invention.

FIG. 3 shows a deposit receipt consistent with one aspect of the invention.

### DETAILED DESCRIPTION

The present invention provides a shared location for financial institutions. A shared location is one where transactions can be received for multiple financial institutions in a single location. A network of these shared locations can be used by a financial institution in conjunction with or in place of non-shared locations. The transaction may subsequently processed by a financial institution, such as a bank, a savings and loan, a stock brokerage or by a related intermediary such as a government reserve bank or market exchange.

A transaction can be a deposit, a withdrawal, a transfer, a change in items held in an account or an informative communication. A deposit may include, for example, a receipt of money or of a negotiable instrument, which is to be placed in an account. A withdrawal can include the removal of money from the account to an unrelated account or in the form of cash. A withdrawal could occur, for example, by wire transfer, by check, by a teller, or by an automated teller machine. A transfer can include movement of money from one account to another account at any of the financial institutions at which the customer is authorized. A change in items held in an account could include the purchase or sale of stocks or other financial instruments such as a bond. An informative communication includes obtaining information from a financial institution by a telephone conference, an email, an instant message, a web site, or a video conference.

An account may include a bank account or a brokerage account. Examples of accounts in accordance with the present invention include a savings deposit account, a checking account, a money market account, a brokerage account or any account where items possessing monetary value can be held.

Associated with a record of the transaction is an identification of an account and an identification of the customer and financial institution. The identification of the account may be, for example, an account number provided by the financial institution. The identification of the customer includes, but is not limited to, an account code, a picture, a signature, a government issued identification card such as a passport or driver's license, or a biometric identification such as a fingerprint, a voice print, or a face print. The identification of the customer can be recorded with the other transaction data and printed on a transaction record, such as a printed receipt or database entry. For example, an image of a customer can be taken by a camera and the image reproduced on the transaction record for the financial institution.

Additionally, other transaction data can be recorded and printed for the customer or the financial institution. A deposit slip, a deposited negotiable instrument such as a check, or any other document associated with the transaction can be imaged and recorded. A transaction record can then be printed or electronically transmitted as necessary to complete the transaction. In one embodiment of the invention, the transaction could be completed by the financial institution without requiring the original transaction documents.

Certain aspects of the invention include real-time document routing and printing, customer authentication, courier services for documents, stock certificate handling, and document imaging and return. Additionally, the invention provides acceptance of deposits which may or may not include checks and cash. Documents that could be imaged at the point of transfer from a customer to the shared location of the invention include deposit data such as checks and deposit tickets. The customer could also be imaged at the time of a transfer and the image could form part of the transaction record. Customer authentication could include any of a number of biometric measurements or a personal identification code. Such measures could be used to prevent unauthorized or fraudulent transactions. In one embodiment of the invention, the shared location functions as a conduit for the such that the financial institution remains the “Bank of First Deposit” for check clearing purposes. The shared location is preferably not a branch of the financial institution or member firm.

Shared locations can have equipment for video conferencing such that a customer can communicate with a financial institution at the shared location. Agents of the shared location can assist customers with establishing a video connection. The customer may also be able to provide images of documents directly to the financial institution or member firm. The shared location could also provide telephones with priority service at a member firm and Internet terminals for customers to conduct other financial business.

Agents or employees of the shared locations can supply customers with information to conduct transactions with the financial institutions or member firms. Preferably the agents are specially trained for detecting suspicious or fraudulent transactions.

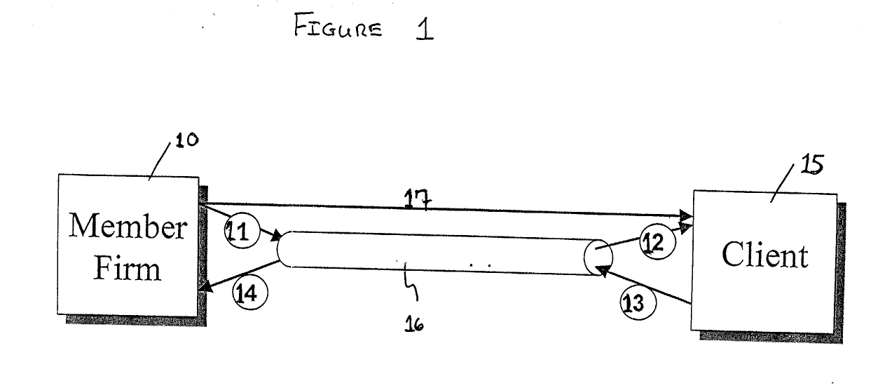

As illustrated in FIG. 1, a simplified data delivery path in accordance with the shared location of the present invention is shown. A member firm or financial institution 10 can transmit data to a client or customer 15 in a remote location via the member firm to client pathway 17. Likewise, a customer could transmit data to the financial institution directly. The financial institution 10 may also transmit data to a shared location 16 via the member to shared location pathway 11. The data at the shared location can be transmitted to the customer 15 via the shared location to customer pathway 12. Also as shown in FIG. 1, the information pathways 11 and 12 are reversed in pathways 14 and 13 respectively.

The data can be in any form, including, but not limited to, an electronic form such as an email or a printed document. In one embodiment, documents are printed on demand either by the customer or an employee or agent of the shared location. The employee or agent of the shared location can assist the customer and the financial institution with document processing and authentication of documents or the identity of the customer. In another embodiment, the data is transmitted in real-time across a network between the financial institution and the shared location. Additionally, if the data is transferred in the form of printed documents, there may also be an electronic transfer of document images that are recorded with a transaction. Such electronic transfer could decrease the processing time for a transaction to be completed.

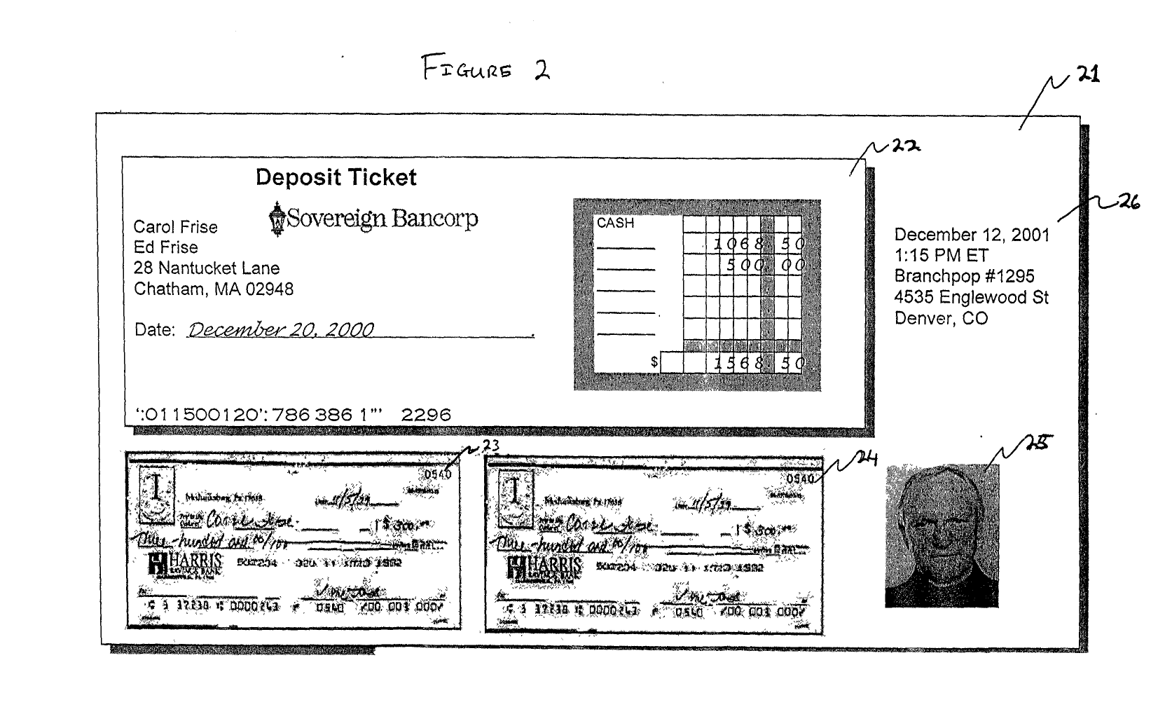

FIG. 2 shows a deposit record 21 consistent with the invention, however, not all elements depicted in FIG. 2 are required for a deposit record to be included in the scope of the present invention. The deposit record of FIG. 2 shows an imaged deposit ticket 22 that is typically completed by a customer to list specific transaction data. In the present case, two deposit amounts are listed on the deposit ticket as well as the transaction date completed by the customer, the account holders' names, an account identifier as well as a financial institution logo. Two imaged checks 23 and 24 are shown on the deposit record 21, as well as a customer image 25. Additionally the deposit record shows additional transaction data 26 such as a date and time, a location number for one shared location in an affiliated network of locations, and a street address. In some embodiments, multiple shared locations can be affiliated by a network by which information is shared or by common ownership or franchise. All or some of the transaction data in the deposit record could be transmitted in accordance with the method of the invention from the shared location to the financial institution or the customer.

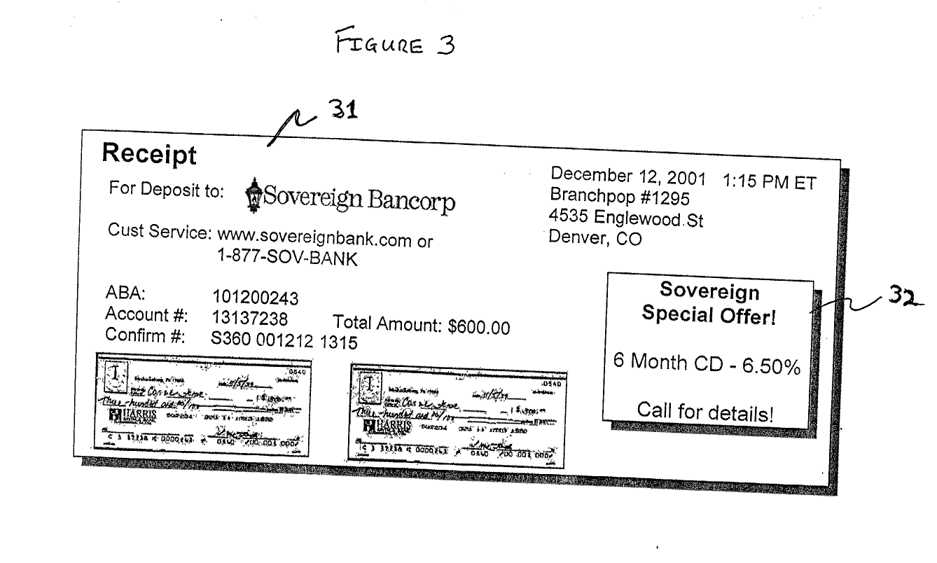

As depicted in FIG. 3, in one embodiment of the invention, transaction data can be provided on a printed receipt 31 for a customer. As the example of FIG. 3 indicates, not all transaction data recorded by the shared location is required to be printed on the receipt. In FIG. 3, the receipt shows promotional information 32 that is not related to the transaction. Thus, the receipt can be used to provide information to the customer such as advertisements, location hours and dates of operation, telephone numbers for assistance.

The invention is also understood from the claims that follow. The preceding description of the invention should not be construed as limiting the invention as claimed.

The claimed invention is:

1. A method for receiving transaction data for a plurality of financial institutions at a shared location, comprising:
receiving first data about a first transaction for a first financial institution at the shared location;
receiving second data about a second transaction for a second financial institution at the shared location; and
providing at the shared location a person not employed by the first or the second financial institution to assist a respective customer at the shared location with a respective transaction.

2. The method of claim 1, further comprising providing the corresponding data to the respective financial institution.

3. The method of claim 2, further comprising processing the corresponding transaction by the respective financial institution.

4. The method of claim 1, wherein the corresponding data identifies the corresponding transaction for the respective financial institution.

5. The method of claim 4, wherein the corresponding data includes an account identifier recognizable by the respective financial institution.

6. The method of claim 5, wherein the account identifier is an alphanumeric sequence.

7. The method of claim 4, wherein each data includes a customer identifier and a transaction amount.

8. The method of claim 7, wherein the customer identifier is a personal identification code.

9. The method of claim 8, wherein the customer identifier includes a biometric measurement of the respective customer.

10. The method of claim 9, wherein the biometric measurement is selected from the group consisting of a signature, a fingerprint, a voiceprint, a face scan, and a retinal scan.

11. The method of claim 1, comprising printing a transaction record with corresponding transaction data.

12. The method of claim 11, comprising providing the printed transaction record to the respective customer.

13. The method of claim 11, comprising printing the transaction record with an image depicting a customer's face.

14. A printed transaction record for a deposit to an account, comprising an amount of a transaction, an account identifier, and an image depicting a customer's face.

15. The printed transaction record of claim 14, further comprising an image of a negotiable instrument being deposited to the account.

16. The printed transaction record of claim 14, further comprising an image of a deposit slip submitted by the customer for the transaction.

17. A shared location for receiving transaction data for financial institutions, comprising:
a location having an agent capable of receiving transaction data from a plurality of customers;
wherein first data about a first transaction for a first financial institution can be received; and
wherein second data about a second transaction for a second financial institution can be received.

18. The shared location of claim 17, comprising an image recorder and a printer for generating printed transaction records.

19. The shared location of claim 18, further comprising a videoconferencing apparatus thereby permitting an informative transaction.

20. The shared location of claim 17, wherein the location is one of a plurality of affiliated shared locations.
